(19) United States
(12) Patent Application Publication
(10) Pub. No.: US 2016/0301771 A1
(43) Pub. Date: Oct. 13, 2016

(54) MATCHING PROBLEM DESCRIPTIONS WITH SUPPORT TOPIC IDENTIFIERS

(71) Applicant: MICROSOFT TECHNOLOGY LICENSING, LLC, Redmond, WA (US)

(72) Inventors: Ankit Choudhari, Bothell, WA (US); Asha Sundaravaradan, Sammamish, WA (US)

(73) Assignee: MICROSOFT TECHNOLOGY LICENSING, LLC, Redmond, WA (US)

(21) Appl. No.: 14/685,401

(22) Filed: Apr. 13, 2015

(51) Int. Cl. H04L 29/08; G06F 17/27; H04L 12/58

(52) U.S. Cl. CPC H04L 67/327; H04L 67/306; H04L 51/04; G06F 17/2775; G06F 17/27

(57) ABSTRACT

An input of natural language text can include at least a portion of a textual description of a problem with a product. A request to match the problem description with a support topic identifier can be sent, where the support topic identifier can be assigned to a support agent profile group that includes one or more computer-readable support agent user profiles. A request to generate a computer-readable support ticket can also be sent. The support ticket itself can be included in a request for a communication from a support agent profile group regarding the problem described in the problem description. A request to use the support topic identifier to send the support ticket to the support agent profile group can be also be submitted. Additionally, a communication received from the support agent profile group in response to the support ticket can be accessed and sent to an output device.

### BACKGROUND

To allow for correct routing of support tickets through computer systems, current systems provide portals such as Web portals (e.g., a Web page that prompts for user input for submitting the support ticket). User input is provided to the portals to select from pre-defined options using user interface features such as drop-down menus or check boxes. Such options may include the type of product with which the user is having a problem, the feature of the selected product with which the user is having a problem, and the problem that the user is having with the selected feature. After user input has been provided to select from the various options, the combination of options selected can result in a support topic identifier being assigned and a support ticket being generated. The support topic identifier is linked to a support topic, and the support topic identifier is used to route the support ticket through a computer system (e.g., through computers, computer networks, etc.) to a correct group of support agent(s) assigned to handle inquiries regarding problems matching the same set of option selections as the generated ticket. In other words, the support topic identifier is assigned to that group of agents or to the corresponding group of user profiles stored in a computer system. As used herein, a support ticket is a computer-readable set of data that requests a communication response to assist with a specified problem with a product.

### SUMMARY

In one aspect, the tools and techniques can include receiving a digital data transmission indicating that assistance from one or more support personnel is to be requested. In response to receiving this transmission, a digital prompt can be accessed and sent to an output device of a computer system. An input of natural language text received in response to the prompt can be accessed. The natural language text can include at least a portion of a textual description of a problem with a product. As the natural language text is being input, a portion of the natural language text already received can be matched with previously stored text, and the previously stored text can be automatically sent to the output device as a suggestion. A digital data transmission indicating that the textual description of the problem with the product is completely entered can be receiving through an input device of the computer system. In response to the transmission indicating that the textual description of the problem with the product is completely entered, a request can be sent. The request can be a request to match the description of the problem with a support topic identifier that is assigned to a support agent profile group comprising one or more computer-readable support agent user profiles. A request to generate a computer-readable support ticket can be sent to a support ticket generation component. The support ticket can request a communication from a support agent profile group regarding the problem described in the description of the problem. A request to use the support topic identifier to send the support ticket to the support agent profile group can be sent. Additionally, a transmission representing a communication received from the support agent profile group in response to the support ticket can be accessed. The communication received from the support agent profile group can be sent to an output device.

This and other aspects of the tools and techniques of the current patent application are discussed below.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a schematic diagram of a product support environment or system.

FIG. 3 is a schematic diagram of components of the product support environment or system of FIG. 2.

FIG. 4 is a schematic diagram of a graph of terms, which is a data structure component of the support environment or system of FIGS. 2-3.

FIG. 5 is a schematic diagram of a leaf node of the graph of terms illustrated in FIG. 4.

FIG. 6 is a flowchart of a technique for matching problem descriptions with support topic identifiers.

FIG. 7 is a flowchart of another technique for matching problem descriptions with support topic identifiers.

FIG. 8 is a flowchart of yet another technique for matching problem descriptions with support topic identifiers.

### DETAILED DESCRIPTION

Aspects described herein are directed to techniques and tools for improvements to computing systems that handle support tickets using topic identifiers. Such improvements may result from the use of various techniques and tools separately or in combination.

Such techniques and tools may include providing a computer system that allows a user to enter a problem with a product (e.g., software, service, computer hardware, other goods, etc.) as natural text through an input device. The computer system can prompt the user through an output device to auto-complete the problem by providing one or more suggestions based on what the user started entering. The user may select such a suggestion, and the computer system can map the suggestion to a support topic identifier using a mapping data structure that maps topic description phrases to topic identifiers. Or, if the computer system is not provided with a description that matches an entry in the mapping data structure, then the user can type his/her own description of the problem, and allow the computer system to break the description (e.g., a phrase such as one or more sentences) down into important terms (such as matching only single words, or matching combinations of single words and multi-word phrases) and use a graph of terms to match the user's description with a topic identifier. The graph of terms can provide different weights for different terms that are matched (i.e., where a description includes a term that matches a term in a specific node of the graph of terms). The computer system can provide a self-learning feature for the graph of terms. The computer system can receive and use feedback from the user if the selection was correct, and can also use feedback from users and/or support personnel when a selection previously made by the computer system using the graph of words was incorrect. The computer system can use feedback to increase weight of matching terms that led to correct matches of descriptions to topic identifiers, and can decrease weight of matching terms that led to incorrect matches of descriptions to topic identifiers. The decreasing and/or increasing of weights may only be done if there have been enough feedback instances to justify such results. For example, decreasing of weights may only be performed if a threshold number of matching instances were incorrect according to the feedback. In some instances, due to negative feedback regarding incorrect matches, words may be removed from the graph of words.

Accordingly, one or more substantial benefits can be realized from the tools and techniques described herein. For example, the computer system can be improved by providing a more efficient experience for the user, where the user can provide natural language text, which may be assisted with suggestions based on already-entered text, to provide the computer system with information to match the user's problem with a support topic identifier. Additionally, the system can decrease rates of errors resulting from users making inappropriate choices when selecting from multiple different options, such as in multiple different drop down menus or checkbox lists, to provide information for identifying a support topic identifier for a problem. Resulting inappropriate or incorrect assignments of support topic identifiers for support tickets can result in support tickets being sent to the wrong support agent profile groups, resulting in the support tickets being forwarded or otherwise re-assigned. Accordingly, the system and techniques discussed herein can decrease computer resource usage by decreasing unnecessary communications, processor usage, transmissions, wasted computer storage, etc. that can result from assigning inappropriate or incorrect support topic identifiers to support tickets. Thus, the features discussed herein can make more efficient and effective use of computer resources in determining support topic identifiers for computer-readable support tickets, and in generating and routing computer-readable support tickets to provide product support communications from appropriate user profile groups.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

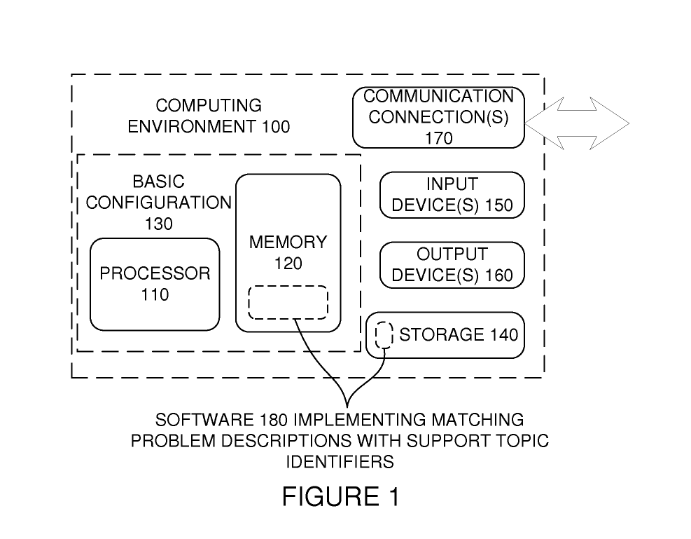

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment 100 in which one or more of the described aspects may be implemented. For example, one or more such computing environments can be used as a client device, server, and/or a support agent device. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment 100 is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment 100 includes at least one processing unit or processor 110 and memory 120. In FIG. 1, this most basic configuration 130 is included within a dashed line. The processor 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory), or some combination of the two. The memory 120 stores software 180 implementing matching of problem descriptions with support topic identifiers. An implementation of matching problem descriptions with support topic identifiers may involve all or part of the activities of the processor 110 and memory 120 being embodied in hardware logic as an alternative to or in addition to the software 180.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment 100 may have additional features. In FIG. 1, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The memory 120 can include storage 140 (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment 100. The storage 140 stores instructions for the software 180.

The input device(s) 150 may be one or more of various different input devices. For example, the input device(s) 150 may include a user device such as a mouse, keyboard, trackball, etc. The input device(s) 150 may implement one or more natural user interface techniques, such as speech recognition, touch and stylus recognition, recognition of gestures in contact with the input device(s) 150 and adjacent to the input device(s) 150, recognition of air gestures, head and eye tracking, voice and speech recognition, sensing user brain activity (e.g., using EEG and related methods), and machine intelligence (e.g., using machine intelligence to understand user intentions and goals). As other examples, the input device(s) 150 may include a scanning device; a network adapter; a CD/DVD reader; or another device that provides input to the computing environment 100. The output device(s) 160 may be a display, printer, speaker, CD/DVD-writer, network adapter, or another device that provides output from the computing environment 100. The input device(s) 150 and output device(s) 160 may be incorporated in a single system or device, such as a touch screen or a virtual reality system.

The communication connection(s) 170 enable communication over a communication medium to another computing entity. Additionally, functionality of the components of the computing environment 100 may be implemented in a single computing machine or in multiple computing machines that are able to communicate over communication connections. Thus, the computing environment 100 may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment 100, computer-readable storage media include memory 120, storage 140, and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Problem Support System and Environment

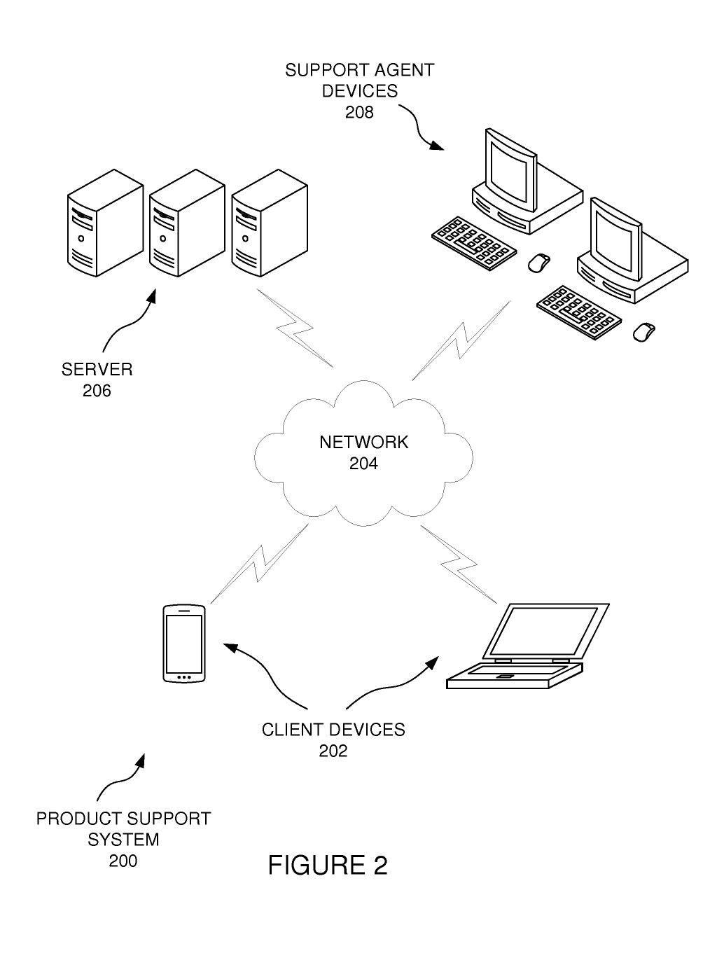

FIG. 2 is a schematic diagram of a product support environment or system 200 in conjunction with which one or more of the described aspects may be implemented. The product support system 200 can include one or more client devices 202, which can communicate via a network 204 with a server 206 and support agent devices 208 to request and receive communications with knowledgeable support agents (persons) using the support agent devices 208. The client devices 202 and support agent devices 208 can be any of various different types of devices, such as telephones, smartphones, desktop computers, laptop computers, tablet computers, etc. A single client device user or support agent may use multiple different devices, and such devices may be associated with a single user profile. A user profile as discussed herein is a computer-readable data structure (or multiple structures that are associated together) that represents a user or group of users, such as a product registration profile, email profile, social network profile, computer login profile, Website login profile, mobile application login profile, etc. Multiple such profiles may be grouped together or associated so that they can be considered a single user profile. When a user profile is active in a machine or portion of a machine (such as where a computer device is logged in with credentials from the user profile), then actions of that machine or portion of a machine may be considered to be actions of the user profile, as used herein (such as when discussing sending to the user profile, receiving from the user profile, etc.).

Communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple request may be sent by sending a single request that requests performance of multiple tasks. For example, a request to generate a support ticket and a request to use a support ticket identifier to send the support ticket to a support agent profile group may be sent as a single request, which requests that a computer system generate the ticket and then use the support topic identifier to send the support ticket to the support agent profile group. The network 204 can include one or more of various types of computer networks that can be configured to work together. The messages sent over such networks or through individual computer components can use one or more existing protocols and computer languages, such as TCP/IP, HTML, etc.

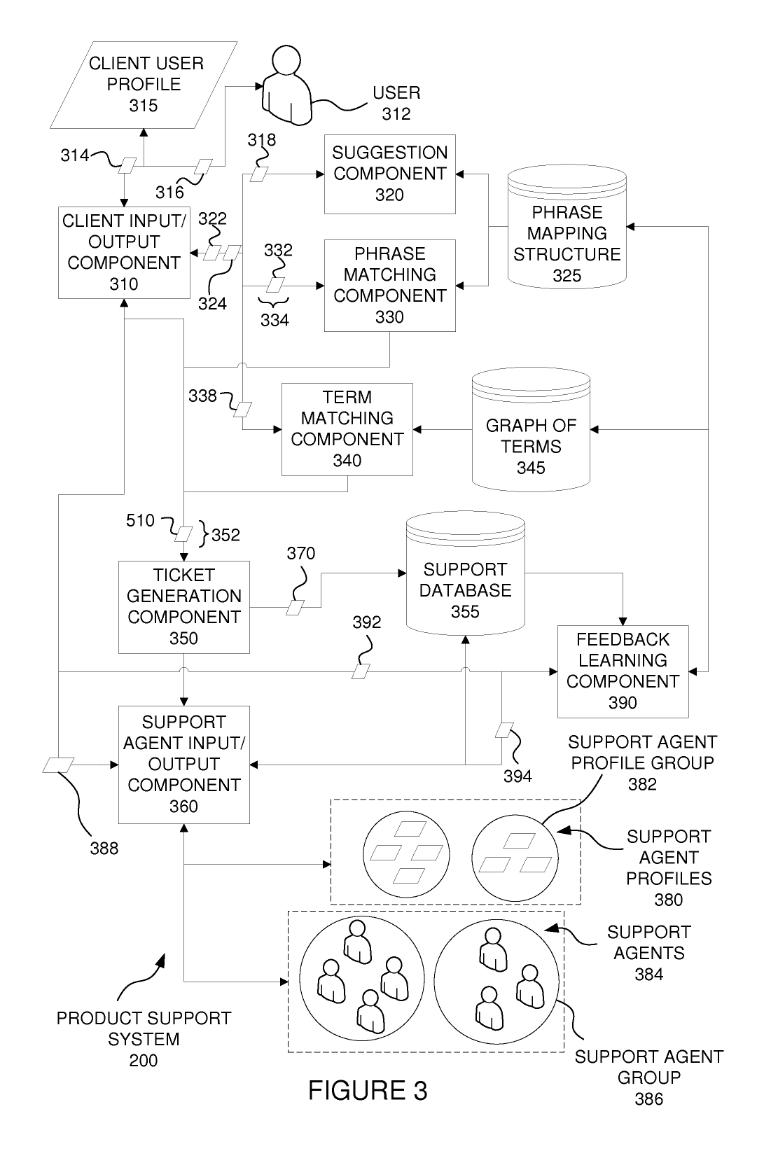

Referring now to FIGS. 2-3, components of the product support system 200 will be discussed. Each of the components includes hardware, and may also include software. For example, a component of FIG. 3 can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices 202 and other operations of the component being performed on one or more machines of the server 206 and/or one or more of the support agent devices 208). In one embodiment, the suggestion component and phrase matching component discussed below may be entirely or partially hosted by a client device 202, while the term matching component, ticket generation component, and feedback learning component discussed below may be hosted entirely or partially by the server 206. The client input/output component 310 may be hosted by the client device 202, while the support agent input/output component may be hosted by the support agent devices 208. However, other arrangements are possible. For example, the phrase matching component may be hosted entirely or partially by the server 206, and the term matching component may be hosted partially or entirely by the client device 202.

A. Client Input/Output Component

The product support system 200 can include a client input/output component 310, which can be associated with a client user profile 315 that represents a user 312. For example, the user 312 can provide login credentials for the client user profile 315 into one or more devices that include input/output devices that are part of the client input/output component 310. Thus, a user 312 can provide input into the client input/output component 310 through one or more input devices (e.g., an input device that includes a touch screen, keyboard, computer mouse, microphone, etc.), such as input devices 150 of FIG. 1, which can be devices in a single client device 202 or multiple client devices 202. Additionally, the user 312 can receive output into the client input/output component 310 through one or more output devices (e.g., an output device that includes a computer display, a speaker, etc.), such as the output devices 160 of FIG. 1.

The client input/output component 310 can prompt the user 312 for user input, such as by displaying a prompt (e.g., a text entry box, a checkbox, a selection menu, etc.) that requests user input. The client input/output component 310 can also receive user input from the user 312. The client input/output component 310 can also interact with other components to receive and present information to the user 312, and to receive user input from the user 312 and send the user input to an appropriate component in the product support system 200.

As an example, the client input/output component 310 can receive and process a digital data service request 314, such as by user input through an input device. The digital data service request can be a transmission indicating that assistance from one or more support personnel is to be requested. The client input/output component 310 can respond by accessing a digital prompt 316 and sending the digital prompt 316 to an output device to be presented to the user 312. The digital prompt 316 can prompt the user to enter a natural language textual description of a problem with a product. For example, the prompt can be a text box presented on a web page or a display of a mobile application. The client input/output component 310 can receive natural language text 318 as it is entered, and can forward the natural language text 318 to a suggestion computing component 320.

B. Suggestion Component

The client input/output component 310 can be configured to interact with the suggestion component 320. The suggestion component 320 can receive and access the natural language text 318 as the natural language text 318 is being entered. The suggestion component 320 can also access a phrase mapping data structure 325 to provide suggestions 322. Alternatively, the suggestion component may access some other suggestion data structure to identify and retrieve suggestions to be provided as discussed below. The phrase mapping data structure 325 is a data structure that maps phrases to support topic identifiers. A phrase can include multiple terms, such as in a sentence. For example, a phrase may state, “Email does not work,” “fan not running,” etc. The phrase mapping data structure 325 can be a mapping database table that includes phrases, and maps each phrase to a support topic identifier that represents a particular support topic, where the support topic includes what is described in the corresponding phrase. As an example, a phrase may be a phrase that is entered by an administrator to describe the topic (such as an official description of the topic, or a phrase that the administrator believes is likely to be entered by users when seeking support for the topic), and/or the phrase may be a phrase that is commonly entered by users 312 when seeking support for the topic.

In response to receiving the natural language text 318 that has already been entered, the suggestion component 320 can search the phrase mapping data structure 325, such as by searching the phrase mapping data structure itself or searching an index of terms in or associated with the phrase mapping data structure 325, for phrases that match the natural language text 318. In one example, the phrase mapping data structure 325 can provide a suggested phrase from the phrase mapping data structure 325 as a suggestion 322 only if the suggested phrase includes an exact match for the natural language text 318 already entered (though the suggestion 322 could include addition text as well). In another example, the suggestion component 320 may provide matching phrases from the phrase mapping data structure 325 as suggestions 322 if those matching phrases match according to a keyword search process, which may include matching words from the natural language text 318, matching other forms of the words from the natural language text 318, matching synonyms of words from the natural language text 318, etc. If multiple suggestions 322 are provided for a single set of natural language text 318 being entered, then the suggestions 322 may be ordered by a combination of one or more factors, such as popularity of the suggestion 322, textual similarity of the suggestion 322 to the natural language text 318 already entered, and/or other such factors.

The suggestion component 320 can send the suggestion(s) 322 to the client input/output component 310 to instruct the client input/output component 310 to present the suggestion 322 to the user, such as by supplying the suggestion(s) 322 to a renderer for displaying on a computer display or by supplying the suggestions to a text-to-speech component to be read to the user 312 using a speaker output device.

User input can be provided by the user 312 (which, as with other instances of user input discussed herein, can be considered to be provided by the client user profile 315 that is active on the client machine interacting with the client input/output component 310) to select the suggestion 322 or to indicate that the entered the natural language text 318 is complete. Such user input can prompt the client input/output component 310 to produce a transmission 324 indicating that the textual description of the problem with the product is completely entered.

The client input/output component 310 can respond to the indication that the entered text is complete by forwarding the suggestion 322 or the entered natural language text 318 to a phrase matching component 330 as a problem description 332, which can be a description of a problem with a product for which support communications from a support agent is to be obtained. The problem description 332 can be included in a phrase matching request 334, which is a request to match the problem description 332 with a support topic identifier.

C. Phrase Matching Component

The phrase matching component 330 can respond to the phrase matching request 334 by accessing the received problem description 332, accessing the phrase mapping data structure 325, and searching the phrase mapping data structure 325 to determine whether the phrase mapping data structure 325 includes a phrase that is an exact match for the problem description 332. Alternatively, the phrase matching component 330 can determine that a phrase in the phrase mapping data structure 325 is a match for the problem description 332 if the phrase is sufficiently similar to a phrase in the phrase mapping data structure. For example, the phrase matching component 330 may consider phrases and problem descriptions to be matching if they only differ in terms of punctuation or capitalization, only if they differ by less than a predetermined threshold amount of textual difference, etc.

If the phrase matching component 330 does not find a matching phrase for the problem description 332 in the phrase mapping data structure 325, then the product support system 200 can respond by sending a term matching request 338 to a term matching component 340, and that term matching request can include the problem description 332.

D. Term Matching Component

The term matching component 340 can respond to receipt of the term matching request 338 by accessing and utilizing the problem description 332 and a graph of terms 345 to match the problem description 332 to a support topic identifier. To do this, the term matching component 340 can first break the problem description (332) down into what are deemed important terms according to pre-defined break-down techniques stored in the product support system and accessed by the term matching component 340. Breaking down the problem description 332 can include parsing the problem description 332 to split the problem description 332 into its terms. The breaking down can also include removing terms that are deemed dispensable by the break-down technique. Such dispensable terms can include terms such as numbers (whether written in digits or spelled out as words), conjunctions, qualifiers, articles, relative clauses, negatives, interjections, and/or interrogatives. Additionally, terms that remain after removal of dispensable terms can be transformed into those remaining terms' corresponding root forms, such as root words. For example, such transformations can include removing suffixes and/or prefixes from words (e.g., transforming “running” into “run”), transforming words into present tense forms (e.g., transforming “ran” into “run”), and/or performing other transformations on terms.

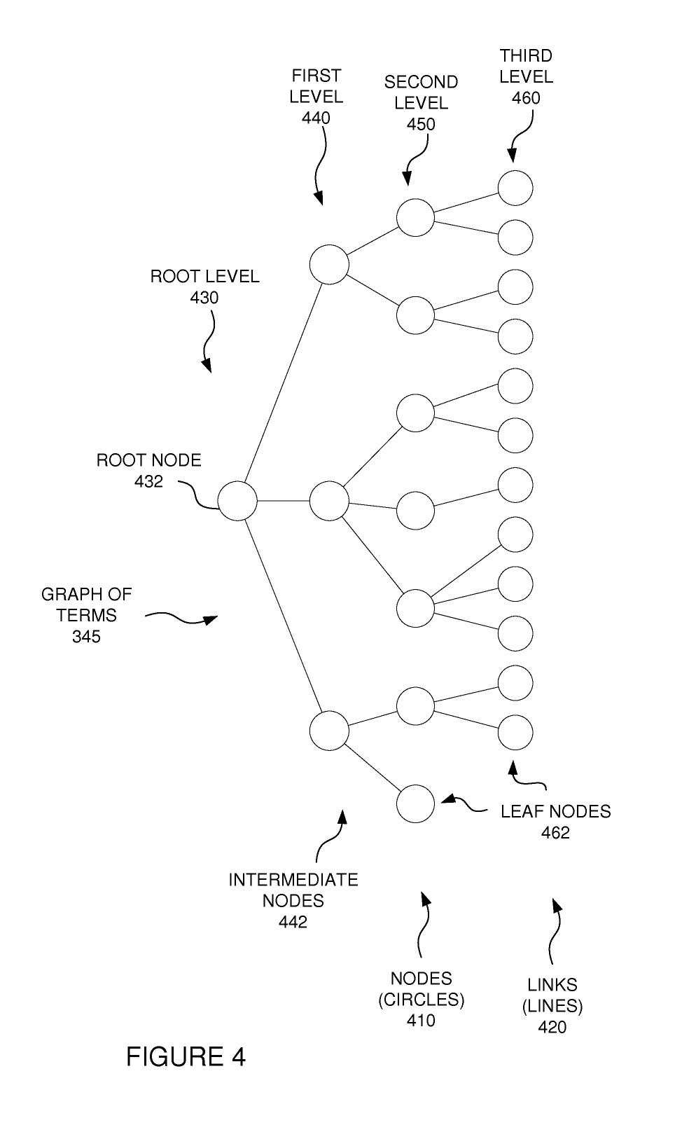

After breaking down the problem description 332 into its terms that are deemed important according the stored break-down technique, the term matching component (340) can use a scoring technique to determine a matching score using the graph of terms 345. Referring to FIG. 4, a graph of terms is illustrated in schematic form. The graph of terms 345 is a data structure that is stored in the product support system of FIGS. 2-3, such as in the server 206 or in a storage location accessible by the server 206. The graph of terms can include multiple nodes 410, schematically illustrated as circles in FIG. 4. The nodes 410 can be linked together by links 420, schematically illustrated as lines between the circles in FIG. 4. The graph of terms 345 can be arranged in a tree structure with multiple levels. For example, the graph of terms 345 can include a root level 430 with a single root level node 410, which may be different from other nodes 410 in the graph of terms 345. For example, the root level node 410 may simply include links to nodes in a first level 440 that is arranged below the root level 430. The first level 440 can include intermediate nodes 442 (nodes between the root node 432 and leaf nodes discussed below). Each of those intermediate nodes 442 can include one or more links to nodes above (to the left in FIG. 4, away from leaf nodes and toward the root node 432) and/or below (to the right in FIG. 4, toward the leaf nodes and away from the root node 432) them in the graph of terms 345. For example, the intermediate nodes 442 in the first level 440 can include links to nodes below those nodes 442 in a second level 450 of the graph of terms 345. Similarly, the intermediate nodes 442 in the second level 450 of the graph of terms 345 can include links to nodes below those nodes 442, such as nodes in the third level 460. Eventually, the links 420 in the intermediate nodes 442 can lead down to leaf nodes 462, which are nodes 462 that have no other nodes 410 linked below them.

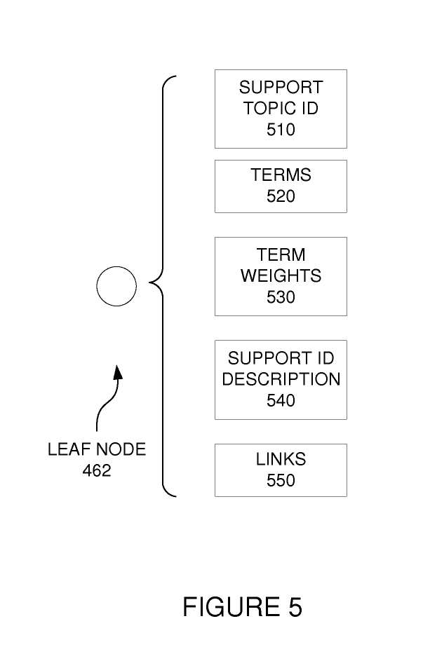

Referring now to FIG. 5, a schematic illustration of a leaf node 462 is illustrated. Each of the items of the items in a leaf node 462 may not be located immediately adjacent to each other in the graph of terms 345. Indeed, all the data in the graph of terms 345 may or may not be located in a continuous manner, but may be distributed in different areas of one or more storage devices. The same is true of storage of other data structures discussed herein, such as the phrase mapping data structure 325 discussed above.

Each leaf node 462 can include a support topic identifier 510, as well as terms 520 for the leaf node 462. The leaf node 462 can also include term weights 530, which can include, for each of the terms 520, a term weight 530 to be applied to the matches of that term 520 in broken down terms from a problem description being analyzed. The leaf node 462 can also include a support identifier description 540, which can be a description that corresponds to the node, such as “webmail will not send emails.” Indeed, the leaf node 462 may include a plurality of such descriptions. For example, the support identifier description 540 may be the same as a phrase corresponding to a support topic identifier 510 for the leaf node in the phrase mapping data structure 325 discussed above. Additionally, the leaf node 462 can include links, such as a link to one or more parent nodes (e.g., a link to a parent node, a grandparent node, etc.).

The intermediate nodes 442 can be similar to the leaf nodes 462, except that the intermediate nodes 442 can omit the support topic identifier, and the links for an intermediate node may additionally include links to child nodes of the intermediate node 442.

Referring to FIGS. 3-5, when the term matching component 340 performs term matching to assign a support topic identifier 510 to a problem description 332, the term matching component can perform a level-by-level analysis through the graph of terms 345 to choose a series of nodes based on scores, thereby traversing the graph of terms 345 from the root node 432 to a leaf node 462. For example, at each level, a node 410 can be chosen from among one or more nodes 410 that are children of a current node. Specifically, a node 410 can be chosen if it has a highest score among the nodes 410 that are children of the current node 410.

Scoring of a node 410 for a problem description 332 can include, for each term in the broken-down terms from the problem description 332 that is included in the terms 520 for the node 410, applying the term weight 530 for that term in that node 410 to produce a term score, and combining all the term scores for matching terms from the problem description 332 (i.e., from the broken down terms derived from the problem description 332) in that node 410. As an example, the term weight 530 can be applied by multiplying the term weight 530 by the number of matches of the term to produce the term score (alternatively, duplicates of terms in the problem description 332 may be eliminated in the breaking down, so that each match would produce a term score equal to the weight for the term), and the term scores can be combined by summing up those term scores to produce a node score for that problem description 332 and node 410 combination. The term matching component 340 can compare that combined score to the combined scores for the other nodes 410 that have the same parent node 410. The node with the highest combined score can be chosen as a selected node at that level of the graph of terms 345.

The term matching component 340 can repeat this selection technique at each level until a leaf node 462 is selected. The term matching component 340 can assign the support topic identifier 510 for that leaf node 462 to the problem description 332.

The graph of terms 345 can take different forms from what is illustrated in FIG. 4 and discussed above. For example, the graph of terms 345 could have different numbers of layers from what is illustrated in FIG. 4. As an example, the graph of terms 345 can take the form of a single-layer graph, wherein a scoring algorithm could be performed over all the nodes to find a node with the highest score, and a support topic identifier for that node could be assigned to the problem description being analyzed. As another example, the graph of terms 345 may have one or more of the nodes 410 with multiple parent nodes (410).

In one of the node selections performed by the term matching component 340, the term matching component 340 may fail to select a node 410. For example, the combined scores for each of the nodes 410 that are being analyzed in the selection (such as nodes in the first level 440, or nodes 410 that are children of a previously-selected parent node 410) may be zero. For example, this can occur when none of the broken-down terms from the problem description 332 are listed as terms 520 in any of the nodes 410 that are being analyzed in the selection. In this scenario, the product support system 200 may inform the client input/output component 310 that no support topic was identified from the problem description 332, and request that the client input/output component 310 provide a prompt, requesting user input from the user to manually select a support topic corresponding to a valid support topic identifier. In response to this, the client input/output component 310 can prompt the user, such as providing the user with a series of one or more pre-defined selections, such as checkbox selection prompts or drop-down menu selection prompts. In this way, the user input from the user 312 can be used to manually select a valid support topic identifier 510 if the phrase matching component 330 and the term matching component 340 both fail to provide a valid support topic identifier 510.

Alternatively, the term matching component 340 may provide a support topic identifier 510, even if the term matching component 340 does not arrive at a leaf node that is selected as having a highest non-zero score. For example, each group of children nodes (sibling nodes) in the graph of terms 345 may include a default leaf node 462 that is to be chosen by the term matching component 340 if none of its sibling nodes being analyzed has a score. As another example, such a default leaf node 462 may be chosen if two or more of the nodes 410 being analyzed have the same score. Such a default leaf node 462 can include a support topic identifier 510, a support identifier description 540 (such as a description of the parent node 410 followed by “—Other”), and a link 550 to the parent node 410. The default leaf node 462 may omit the terms 520 and term weights 530 that would be present in other leaf nodes 462.

As can be seen, different problem descriptions 332 can result in different behavior from the product support system 200. For example, a first problem description 332 can result in the phrase matching component 330 finding a matching phrase in the phrase mapping data structure 325 and assigning a corresponding support topic identifier 510 to that first problem description 332. This can be done without involving the term matching component 340. A second problem description 332 can result in the phrase matching component failing to find a matching phrase in the phrase mapping data structure 325. The product support system 200 can respond to that failure by forwarding a term matching request 338 to the term matching component 340. The term matching component 340 can find a matching support topic identifier 510 for the second problem description 332 using the graph of terms 345, as discussed above. In either scenario, a ticket generation request 352 can be sent to the ticket generation component 350 to use the chosen support topic identifier 510 to generate a support ticket.

E. Ticket Generation Component

The product support system 200 can respond to a support topic identifier 510 being selected by sending to a ticket generation component 350 a ticket generation request 352, which can include the selected support topic identifier 510 from the selected leaf node 462 in the graph of terms 345. Similarly, if the phrase matching component 330 determines that the problem description 332 matched with a phrase in the phrase mapping data structure 325, then the product support system 200 can respond by sending the ticket generation request 352 to the ticket generation component 350, and can include the support topic identifier 510 that was mapped to the matched phrase in the phrase mapping data structure 325. Also, if neither the phrase matching component 330 nor the term matching component 340 identified a matching support topic identifier 510, then a support topic identifier 510 selected manually through the client input/output component 310 can be sent by the product support system 200 to the ticket generation component 350 with the ticket generation request 352.

In response to the ticket generation request 352, the ticket generation component 350 can generate the support ticket 370. The product support system 200 can respond to the generation of the support ticket 370 by storing the support ticket 370 in a support database 355 along with other support tickets 370. The generation of the support ticket 370 may include inserting information received in the ticket generation request 352 into a support ticket template, or otherwise transforming the information in the ticket generation request 352 and/or accessing other information in response to the ticket generation request 352. Indeed, the generation of the support ticket 370 may comprise merely forwarding the ticket generation request 352 or a portion thereof to be sent and/or stored as a support ticket 370.

F. Support Agent Input/Output Component & Support Agent Profiles

Additionally, the support ticket 370 can be routed to an appropriate support agent input/output component 360, which can include multiple input/output devices in multiple input/output machines, such as the support agent devices 208 discussed above. The support agent input/output component 360 can interact with support agents 384 that include a particular support agent group 386 that is assigned responsibility for responding to support requests assigned the particular support topic identifier 510 that was assigned to the problem description 332. The support agent input/output component 360 can also interact with support agent profiles 380, each of which is a user profile for support agent or a group of support agents. For example, a support agent 384 may be logged in with credentials from a corresponding support agent profile 380, so that the support agent profile 380 is considered active for that support agent 384, and so that data items (e.g., support tickets 370) sent to an environment where the support agent profile 380 is active are considered to be sent to the support agent profile 380, and also sent to the corresponding support agent profile group 382 that includes the support agent profile 380 and that can be one of multiple support agent profile groups 382 in of the support agent profiles 380. Additionally, such data items are considered to be sent to the corresponding support agent group 386 and to the corresponding support agent 384. The support agent profile group 382 can be one of various different support agent profile groups 382 in the support agent profiles of the product support system 200. Notably, the support agents 384 and the user 312 are not considered to be part of the product support system 200. Rather, the support agents 384 and the user 312 are persons who interact with the product support system 200, which is a computer system.

The product support system 200 can send the support ticket 370 to the support agent input/output component 360 and to the assigned support agent profile group 382 (e.g., by sending the support ticket 370 to a support agent profile 380 in the support agent profile group 382) for the support topic identifier 510 in any of various ways. For example, the product support system 200 may provide the support agent input/output component 360 with a notification of the support ticket 370, and that notification can include a location of the support ticket 370 in the support database 355, such as an address or a pointer to the location of the support ticket 370. As an alternative to or in addition to such a notification, the product support system 200 may send the support ticket itself to the support agent input/output component 360 to be provided to support agent(s) 384 in the assigned support agent profile group 382.

In addition to the support ticket 370 acting as a request for support, the support ticket 370 may also act as a data structure to track activity with respect to the request for support. Indeed, the support ticket 370 may include multiple parts that may be stored together or separately, such as one part to request a support communication, and another part to track activity associated with the request for support communication. User input may be provided from a support agent 384 to add information (notes regarding the support request, etc.) to the support ticket 370. Additionally, a support agent profile 380 can respond to the support ticket 370 by sending a communication 388 to the client user profile 315 that requested the support, via the client input/output component 310. The communication 388 may comprise a series of communications, which may be a continuous two-way communication, a one-way communication or a combination of such communications. For example, the communication 388 may be an email message, a text message, a chat session, an audio call, an audio-video conference, and/or another communication involving the product support system 200.

G. The Feedback Learning Component and Generating the Graph of Terms

Referring now to FIGS. 4-5, generation of the graph of terms 345 can include seeding the graph with a basic graph structure of links 420 and nodes 410. For example, this basic structure can be defined by user input from a system administrator user. A feedback learning component 390 can access and use previously-stored support tickets 370 in the support database 355 to provide weights for the nodes 410. For example, for each stored support ticket 370, the support ticket 370 can include a problem description 332, such as a problem description 332 previously entered by user input text, as well as a support topic identifier 510 that was indicated by user input to be a correct support topic identifier 510 for that support ticket 370. For example, each such support ticket 370 can be a ticket where the support topic identifier 510 was determined from manual user input from a user 312 (e.g., as a result of the user selecting menu items or check boxes to arrive), or where an automated selection of the support topic identifier was confirmed by user input from a client user 312 (such as a customer of the product, where the customer is having a problem with the product for which the customer is seeking support) or a support agent 384. User input could have also provided the problem description 332 for the support ticket 370, such as by entering text into a text box, which was then included in the support ticket 370.

The feedback learning component 390 can break down the problem description 332 from each support ticket 370 into what are deemed the important terms according to a technique defined in the product support system 200. This can be done in the same manner that the term matching component 340 breaks down problem descriptions into what are deemed their important terms, as discussed above. For the leaf node 462 to which the support topic identifier 510 of the support ticket 370 is assigned, the feedback learning component 390 can add a set amount (such as a value of one) to the weight corresponding to each term in the broken-down set of terms derived from the problem description 332 in the support ticket 370. Additionally, for terms in the broken-down set of terms derived from the problem description 332 in the support ticket 370 that are not yet in the terms 520 of the leaf node 462, such terms can be added along with adding the set amount of weight for such terms to the term weights 530 of the leaf node 462.

The feedback learning component can also add terms 520 and term weights 530 to each ancestor node of the leaf node 462 to which the support topic identifier 510 of the support ticket 370 is assigned (the parent node above the leaf node 462 if there is such a parent node in the graph of terms 345, the grandparent node above the leaf node 462 if there is such a grandparent node in the graph of terms 345, etc.). However, this may not be done for the root node 432 because, as discussed above, the root node 432 may not include such terms 520 and term weights 530.

The added weights from instances of different terms may be defined to be different, according to stored configuration of the learning feedback component 390. For example, if a term 520 is a root word for a word in a stored support identifier description 540 for a node 410, then the weight for that term 520 may be increased by a factor (which may be done by decreasing all other terms the factor). For example, the weight for such a term may be multiplied by two, or some other number. Other techniques for increasing or decreasing weights for terms deemed to have greater importance may also be used. For example, the product support system 200 may increase or decrease weights for particular terms in response to user input from a system administrator.

The feedback learning component 390 can continue this adding of terms 520 and term weights 530 to the leaf nodes 462 to which the support topic identifiers 510 of the support tickets 370 are assigned and to the ancestors of such leaf nodes 462 until the feedback learning component 390 has processed a defined set of support tickets 370. For example, the feedback learning component 390 may process the past 3-months of support tickets 370 from an existing commercial product support system to add term weights 530 when initially constructing the graph of terms 345.

Besides adjusting weights when initially constructing the graph of terms 345, the feedback learning component 390 can utilize feedback to adjust the term weights 530 in response to subsequent user input feedback. For example, after the term matching component 340 assigns a support topic identifier 510 to a problem description 332, the product support system 200 can send a notification to the client user profile 315 through the client input/output component 310. In response, user input can be provided from the client user profile 315, indicating whether the user 312 believes the assigned support topic identifier 510 to be correct for the problem description 332 entered by user input from the client user profile 315. In response, this user input feedback can be sent as customer user feedback to the feedback learning component 390. In some instances, the customer user feedback 392 may not be immediately provided to the feedback learning component 390. Instead, such customer user feedback 392 may be stored with the corresponding support ticket 370, and may be accessed later by the feedback learning component 390. For example, the feedback learning component 390 may access recent support tickets 370 added since the feedback learning component 390 last accessed the support tickets 370 according to a periodic schedule or some other schedule. Either way, the customer user feedback 392 can be considered to be sent to the feedback learning component 390. User input support agent feedback 394 can also be provided to the feedback learning component 390, such as in a similar manner to how the customer user feedback 392 is provided.

In response to receiving the customer user feedback 392 and/or the support agent feedback 392, the feedback learning component 390 can update the term weights 530 and possibly the terms 520 themselves. For support tickets 370 with positive feedback (indicating the assigned support topic identifier 510 is correct), the feedback learning component 390 can update the graph of terms in the same manner as with the updating in response to terms in the support tickets 370 when initially generating the graph of terms 345. For example, this can include adding a set amount to the term weight 530 for each term that appears in the broken-down set of terms from the problem description 332 in the support ticket 370 for the assigned leaf node 462 and its ancestor node(s) 410.

For support tickets 370 with negative feedback (indicating the assigned support topic identifier 510 is incorrect), the feedback learning component 390 can update the graph of terms 345 in by decreasing the term weight 530 for each term that appears in the broken-down set of terms from the problem description 332 in the support ticket 370 for the assigned leaf node 462 and its ancestor node(s) 410. For example, this may be done if weight had already been added for that ticket. Alternatively, the feedback learning component 390 may respond to such negative feedback by refraining from adding to term weights in the graph of terms for the terms of the corresponding broken-down term set for the support ticket 370. In one scenario, the feedback learning component 390 may wait to act on negative feedback until some threshold has been reached. For example, the feedback learning component 390 may reduce weights for terms that have received a threshold number of negative feedback instances for a particular node, or the feedback learning component 390 may even eliminate terms from the node if a certain threshold amount of negative feedback is received for such terms. Additionally, if the customer user feedback 392 and/or the support agent feedback 394 indicate that a different support topic identifier 510 should have been chosen for the problem description 332, then the feedback learning component 390 can increase weights for the terms in the broken-down term set from the problem description 332 in a leaf node 462 to which that different support topic identifier 510 is assigned (and in ancestor nodes 410 of that leaf node 462). Again, this may be done for each such instance, or it may be done only after a threshold number of similar instance of negative feedback have been received (e.g., with similar terms and dealing with the same support topic identifiers 510).

The feedback learning component 390 may also update the phrase mapping data structure 325. For example, while the feedback learning component 390 is accessing and processing the support tickets 370 to generate or update the graph of terms 345, the feedback learning component 390 can identify phrases that are repeatedly used in problem descriptions 332 for those tickets 370. The feedback learning component 390 can identify instances where a phrase appears at least a predetermined threshold number of times, and where the phrase includes feedback associating it with a support topic identifier 510 a predetermined percentage of times when the phrase appears as a problem description 332 or part of a problem description 332. Such a phrase can be added to the phrase mapping data structure 325, and can be mapped to the corresponding support topic identifier 510. This same type of adding can be done in initially constructing the phrase mapping data structure 325. Additionally, when constructing the phrase mapping data structure 325, the support identifier descriptions 540 (which may be added by user input from system administrator(s)) can be added to the phrase mapping data structure 325, and can be mapped to their corresponding support topic identifiers 510.

Upon being updated and/or generated as discussed in this section, the graph of terms 345 and phrase mapping data structure 325 can be utilized as discussed above.

### III. Support System Description-to-Identifier Matching Techniques

Several techniques will now be discussed for matching problem descriptions with support topic identifiers. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic.

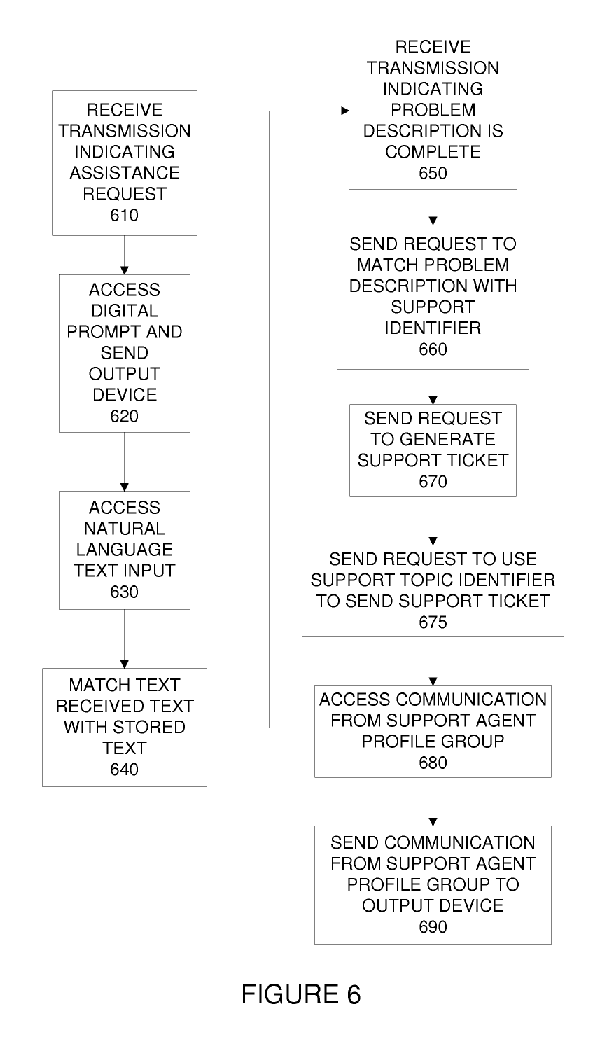

Referring to FIG. 6, a technique for matching problem descriptions with support topic identifiers will be described. The technique can include receiving 610 a digital data transmission indicating assistance from one or more support personnel is to be requested. The technique can further include, in response to receiving 610 this digital data transmission, accessing 620 a digital prompt and sending the digital prompt to an output device of the computer system. An input of natural language text received in response to the prompt can be accessed 630, where the natural language text includes at least a portion of a textual description of a problem with a product. As the natural language text is being input, the technique can include automatically matching 640 a portion of the natural language text already received with previously stored text, and automatically sending the previously stored text to the output device as a suggestion. A digital data transmission indicating that the textual description of the problem with the product is completely entered can be received 650 through an input device of the computer system. In response to this transmission, a request to match the description of the problem with a support topic identifier can be sent 660, where the support topic identifier can be an identifier that is assigned to a support agent profile group that includes one or more computer-readable support agent user profiles. A request to generate a computer-readable support ticket can be sent 670 to request a communication from a support agent profile group regarding the problem described in the description of the problem. A request to use the support topic identifier to send the support ticket to the support agent profile group can be also be sent 675. Additionally, a communication received from the support agent profile group in response to the support ticket can be accessed 680 and sent 690 to an output device.

The transmission indicating that the textual description of the problem with the product is completely entered can include a transmission of a signal resulting from user input selecting the suggestion to make the description of the problem be the previously stored text. The sending 660 of the request to match the description of the problem with the support topic identifier can include sending to a phrase matching component. Also, the technique can further include controlling the phrase matching component to access a phrase mapping data structure that links phrases to support topic identifiers, with the phrase mapping data structure mapping the previously stored text to the support topic identifier. The technique can also include controlling the phrase matching component to use the phrase mapping data structure to match the description of the problem with the support topic identifier.

The request to generate the support ticket can include the support topic identifier and/or the description of the problem. Also, the communication transmission received from the support agent profile group can be selected from a group consisting of a real time audio session transmission, a real time video session transmission, an email message, a text message, a chat message, and combinations thereof. The communication transmission received from the support agent profile group can include a real-time two-way communication from a support agent user profile in the support agent profile group.

In the technique of FIG. 6, the sending 660 of the request to automatically match the description of the problem with the support topic identifier can include sending to a term matching component. The technique can further include controlling the term matching component to perform acts that can include the following: processing the description of the problem to produce a term set that includes a set of terms derived from the description of the problem, the term set being different from the description of the problem; accessing a graph of terms, the graph of terms being a data structure that links terms to support topic identifiers; matching one or more terms in the term set with one or more terms in the graph of terms; using the matching of the one or more terms in the term set with the one or more terms in the graph of terms to generate scores; and comparing the scores to match the term set with a support topic identifier.

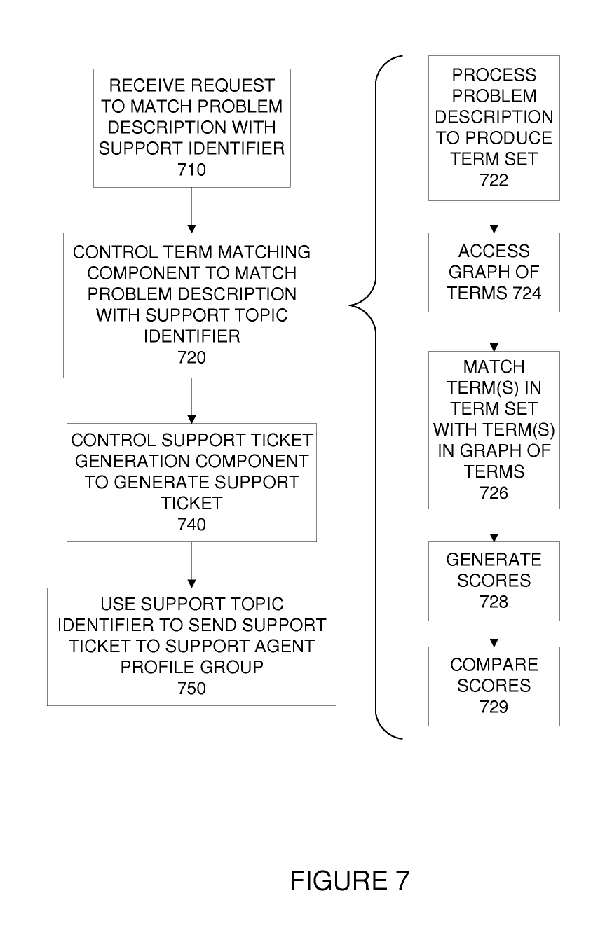

Referring now to FIG. 7, another technique for matching problem descriptions with support topic identifiers will be described. The technique can include receiving 710 from a client user profile a request to match a natural language textual problem description with a support topic identifier, with the natural language textual problem description being received 710 from the client user profile. The technique can include, in response to the request to match, controlling 720 a term matching computing component to match the natural language textual problem description with a support topic identifier. The matching with the term matching computing component can include the following: processing 722 the description of the problem to produce a term set that includes a set of terms derived from the description of the problem, with the term set being different from the description of the problem; accessing 724 a graph of terms, the graph of terms being a data structure that links terms to support topic identifiers; matching 726 one or more terms in the term set with one or more terms in the graph of terms; generating 728 scores based on the matching of the one or more terms in the term set with one or more terms in the graph of terms; and comparing 729 the scores to match the term set with a support topic identifier. The technique can further include controlling 740 a support ticket generation component to generate a support ticket using the support topic identifier. The technique can also include using 750 the support topic identifier to send the support ticket to a support agent profile group. The support ticket can request a communication from the support agent profile group regarding the problem described in the description of the problem, and the support agent profile group can include one or more computer-readable support agent user profiles.

The technique of FIG. 7 can further include sending a responsive communication in response to the support ticket, and the sending of the responsive communication can include sending the responsive communication from the support agent profile group to the client user profile. The responsive communication can be selected from a group consisting of a real-time audio session communication, a real-time video session communication, an email message, a text message, a chat message, and combinations thereof. The sending of the responsive communication can include accessing the support ticket (which may include using the information in the support ticket to send the communication to the client user profile, and using information in the support ticket to send the communication to the client user profile. For example, the client may have entered an email address when submitting a ticket request, and a support agent may send an email to that email address. In this scenario, the submission of the ticket request may be considered to be from the same user profile to which the later email is sent, because both the initial submission and the later email would have indicated the same unique email address.

The processing 722 of the problem description can include the following: accessing a data structure that indicates dispensable terms to be removed from problem descriptions (e.g., a data structure defining a technique for breaking down problem descriptions as discussed above); accessing the description of the problem; identifying one or more dispensable terms in the description of the problem using the data structure; and omitting the one or more dispensable terms from the term set. Moreover, the processing 722 of the description of the problem can further include identifying a word in the description of the problem that is not a root word; converting the identified word into a root word for the identified word; and including in the term set the root word for the identified word.

The graph of terms in the technique of FIG. 7 can be divided into levels, and the matching 726 of the terms in the term set with one or more terms in the graph of terms can include performing term matching at multiple levels of the graph of terms. Also, performing the term matching at multiple levels can include the following: performing term matching for each of multiple nodes in a first level of the graph of terms to produce scores for each of the multiple nodes in the first level; using the scores for the first level of the graph to choose a first level chosen node of the multiple nodes in the first level as a match for the term set; performing term matching for each of multiple nodes in a second level of the graph to produce scores for each of the multiple nodes in the second level, with each of the multiple nodes in the second level of the graph being linked to the first level chosen node, so that the multiple nodes in the second level are grouped under the first level chosen node within the graph of terms; and using the scores for the second level of the graph to choose a second level chosen node of the multiple nodes in the second level as a match for the set of terms, wherein second level chosen node is assigned as a node for the support topic identifier.

Still discussing the technique of FIG. 7, each of the nodes in the graph of terms can include a list of one or more terms for the node and a weight for each of the one or more terms in the list. For each node for which a score is produced, producing the score can include the following: for each term in the term set that matches a term in the list of one or more terms for the node, applying the weight for that term in that node in the graph of terms to produce a single-term score; and combining single-term scores for each term in the term set that matches a term in the list of terms for the node to produce the score for the node. For one or more of the nodes, a weight for a high priority term in the node can be increased in response to determining that the high priority term is a root word for a word in a stored description for the node.

Also, the technique of FIG. 7 can further include accessing feedback from user profiles in response to such user profiles being informed of support topic identifiers being matched to descriptions of problems, and adjusting one or more weights for one or more terms in one or more nodes of the graph of terms using the feedback. The adjusting of the one or more weights can be performed in response to determining that a threshold level of feedback from user profiles has been received for each of the one or more terms in one or more nodes whose weights are to be adjusted. The threshold level can be greater than a single instance of user feedback for each of the one or more terms in one or more nodes whose weights are to be adjusted.

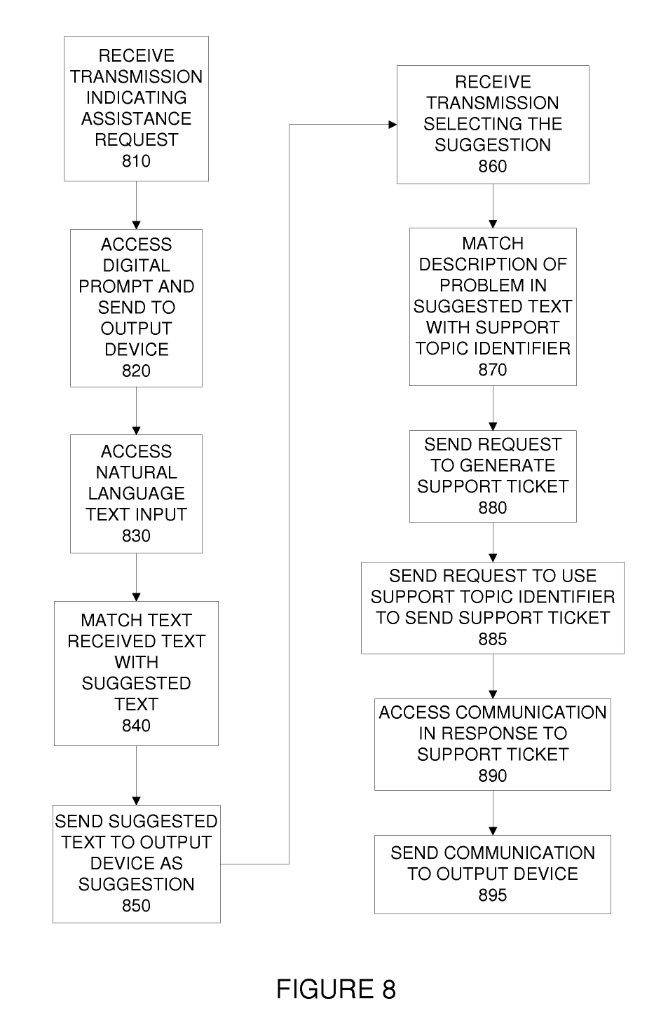

Referring now to FIG. 8, yet another technique for matching problem descriptions with support topic identifiers will be described. The technique can include receiving 810 a digital data transmission indicating assistance from one or more support personnel is to be requested. In response to receiving 810 the digital data transmission indicating assistance from one or more support personnel is to be requested, the technique can include accessing 820 a digital prompt and sending the digital prompt to an output device of a computer system. In response to the digital prompt, an input of natural language text comprising a portion of a textual description of a problem with a product can be accessed 830. As the natural language text is being input, a portion of the natural language text already received can be matched 840 with previously stored suggested text. The suggested text can be automatically sent 850 to the output device as a suggestion. A digital data transmission selecting the suggestion can be received 860 through an input device of the computer system. In response to the transmission selecting the suggested text, the description of the problem, which description is in the suggested text, can be matched 870 with a support topic identifier. This matching 870 can include controlling a phrase matching component to access a phrase mapping data structure that links phrases to support topic identifiers, with the phrase mapping data structure mapping the suggested text to the support topic identifier. The matching 870 can also include controlling the phrase matching component to use the phrase mapping data structure to match the description of the problem with the support topic identifier.

Referring still to FIG. 8, the technique can further include sending 880 to a support ticket generation component a request to generate a support ticket, such that the support ticket requests a communication from a support agent regarding the problem described in the description of the problem. A request to use the support topic identifier to send the support ticket to a destination can be sent 885. A communication received in response to the support ticket can be accessed 890. Further, the communication can be sent 895 to an output device.

### IV. Aspects of Certain Embodiments

Aspects of certain embodiments will now be discussed. According to a first aspect, a technique includes receiving a digital data transmission indicating assistance from one or more support personnel is to be requested. The technique also includes, in response to receiving the digital data transmission indicating that assistance from one or more support personnel is to be requested, accessing a digital prompt and sending the digital prompt to an output device of the computer system. Further, the technique can include accessing an input of natural language text received in response to the prompt, the natural language text comprising at least a portion of a textual description of a problem with a product. Moreover, as the natural language text is being input, the technique can include automatically matching a portion of the natural language text already received with previously stored text, and automatically sending the previously stored text to the output device as a suggestion. A digital data transmission indicating that the textual description of the problem with the product is completely entered can be received through an input device of the computer system. The technique can further include, in response to the transmission indicating that the textual description of the problem with the product is completely entered, sending a request to match the description of the problem with a support topic identifier that is assigned to a support agent profile group comprising one or more computer-readable support agent user profiles. Moreover, the technique can further include the following: sending to a support ticket generation component a request to generate a computer-readable support ticket to request a communication from a support agent profile group regarding the problem described in the description of the problem; sending a request to use the support topic identifier to send the support ticket to the support agent profile group; accessing a communication received from the support agent profile group in response to the support ticket; and sending the communication from the support agent profile group to an output device.

According to the first aspect, the technique described in the previous paragraph may be combined with one or more of the alternative features that follow in this paragraph. The transmission indicating that the textual description of the problem with the product is completely entered can include a transmission of a signal resulting from user input selecting the suggestion to make the description of the problem be the previously stored text. Also, sending the request to match the description of the problem with the support topic identifier can include sending to a phrase matching component. Additionally, the technique can further include controlling the phrase matching component to access a phrase mapping data structure that links phrases to support topic identifiers, with the phrase mapping data structure mapping the previously stored text to the support topic identifier. The technique can also include controlling the phrase matching component to use the phrase mapping data structure to match the description of the problem with the support topic identifier.

According to a second aspect, a technique can include receiving from a client user profile a request to match a natural language textual problem description with a support topic identifier, where the natural language textual problem description is received from the client user profile. The technique can include, in response to the request to match, controlling a term matching computing component to match the natural language textual problem description with a support topic identifier. The matching with the term matching computing component can include the following: processing the description of the problem to produce a term set that includes a set of terms derived from the description of the problem, the term set being different from the description of the problem; accessing a graph of terms, the graph of terms being a data structure that links terms to support topic identifiers; matching one or more terms in the term set with one or more terms in the graph of terms; generating scores based on the matching of the one or more terms in the term set with one or more terms in the graph of terms; and comparing the scores to match the term set with a support topic identifier. The technique can further include controlling a support ticket generation component to generate a support ticket using the support topic identifier. The technique can further include using the support topic identifier to send the support ticket to a support agent profile group. The support ticket can request a communication from the support agent profile group regarding the problem described in the description of the problem, and the support agent profile group can include one or more computer-readable support agent user profiles. According to the second aspect, the features described in this paragraph may be combined with one or more features from the following paragraphs.

The processing of the description of the problem can include accessing a data structure that indicates dispensable terms to be removed from problem descriptions; accessing the description of the problem; identifying one or more dispensable terms in the description of the problem using the data structure; and omitting the one or more dispensable terms from the term set.

The processing of the description of the problem can further include identifying a word in the description of the problem that is not a root word; converting the identified word into a root word for the identified word; and including in the term set the root word for the identified word.

The graph of terms can be divided into levels, and the matching of the terms in the term set with one or more terms in the graph of terms can include performing term matching at multiple levels of the graph of terms.

Performing term matching at multiple levels can include the following: performing term matching for each of multiple nodes in a first level of the graph of terms to produce scores for each of the multiple nodes in the first level; using the scores for the first level of the graph to choose a first level chosen node of the multiple nodes in the first level as a match for the term set; performing term matching for each of multiple nodes in a second level of the graph to produce scores for each of the multiple nodes in the second level, with each of the multiple nodes in the second level of the graph being linked to the first level chosen node, so that the multiple nodes in the second level are grouped under the first level chosen node within the graph of terms; and using the scores for the second level of the graph to choose a second level chosen node of the multiple nodes in the second level as a match for the set of terms, wherein second level chosen node is assigned as a node for the support topic identifier.

Each of the nodes in the graph of terms can comprise a list of one or more terms for the node and a weight for each of the one or more terms in the list.

For each node for which a score is produced, producing the score can include the following: for each term in the term set that matches a term in the list of one or more terms for the node, applying the weight for that tem in that node in the graph of terms to produce a single-term score; and combining single-term scores for each term in the term set that matches a term in the list of terms for the node to produce the score for the node.

The technique according to the second aspect can further include accessing feedback from user profiles in response to such user profiles being informed of support topic identifiers being matched to descriptions of problems; and adjusting one or more weights for one or more terms in one or more nodes of the graph of terms using the feedback.

The adjusting of the one or more weights can be performed in response to determining that a threshold level of feedback from user profiles has been received for each of the one or more terms in one or more nodes whose weights are to be adjusted. The threshold level can be greater than a single instance of user feedback for each of the one or more terms in one or more nodes whose weights are to be adjusted (i.e., a threshold of two instances or a some greater threshold number of instances), such as the threshold level being 50 instances, 100 instances, or some other threshold.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer system comprising:
at least one processor; and
memory comprising instructions stored thereon that when executed by at least one processor cause at least one processor to perform acts comprising:
receiving a digital data transmission indicating assistance from one or more support personnel is to be requested;
in response to receiving the digital data transmission indicating that assistance from one or more support personnel is to be requested, accessing a digital prompt and sending the digital prompt to an output device of the computer system;
accessing an input of natural language text received in response to the prompt, the natural language text comprising at least a portion of a textual description of a problem with a product;
as the natural language text is being input, automatically matching a portion of the natural language text already received with previously stored text, and automatically sending the previously stored text to the output device as a suggestion;
receiving through an input device of the computer system a digital data transmission indicating that the textual description of the problem with the product is completely entered;
in response to the transmission indicating that the textual description of the problem with the product is completely entered, sending a request to match the description of the problem with a support topic identifier that is assigned to a support agent profile group comprising one or more computer-readable support agent user profiles;
sending to a support ticket generation component a request to generate a computer-readable support ticket to request a communication from a support agent profile group regarding the problem described in the description of the problem;
sending a request to use the support topic identifier to send the support ticket to the support agent profile group;
accessing a communication received from the support agent profile group in response to the support ticket; and
sending the communication from the support agent profile group to an output device.

2. The computer system of claim 1, wherein the transmission indicating that the textual description of the problem with the product is completely entered comprises a transmission of a signal resulting from user input selecting the suggestion to make the description of the problem be the previously stored text.

3. The computer system of claim 2, wherein sending the request to match the description of the problem with the support topic identifier comprises sending to a phrase matching component, and wherein the acts further comprise:
controlling the phrase matching component to access a phrase mapping data structure that links phrases to support topic identifiers, the phrase mapping data structure mapping the previously stored text to the support topic identifier; and
controlling the phrase matching component to use the phrase mapping data structure to match the description of the problem with the support topic identifier.

4. The computer system of claim 1, wherein the request to generate the support ticket comprises the support topic identifier.

5. The computer system of claim 1, wherein the request to generate the support ticket comprises the description of the problem.

6. The computer system of claim 1, wherein the communication received from the support agent profile group is selected from a group consisting of a real time audio session transmission, a real time video session transmission, an email message, a text message, a chat message, and combinations thereof.

7. The computer system of claim 1, wherein the communication received from the support agent profile group comprises a real-time two-way communication from a support agent user profile in the support agent profile group.

8. The computer system of claim 1, wherein sending the request to automatically match the description of the problem with the support topic identifier comprises sending to a term matching computing component, and wherein the acts further comprise controlling the term matching component to perform the following:
processing the description of the problem to produce a term set that includes a set of terms derived from the description of the problem, the term set being different from the description of the problem;
accessing a graph of terms, the graph of terms being a data structure that links terms to support topic identifiers;
matching one or more terms in the term set with one or more terms in the graph of terms;
using the matching of the one or more terms in the term set with the one or more terms in the graph of terms to generate scores; and
comparing the scores to match the term set with a support topic identifier.

9. A computer system comprising:
at least one processor; and
memory comprising instructions stored thereon that when executed by at least one processor cause at least one processor to perform acts comprising:
receiving from a client user profile a request to match a natural language textual problem description with a support topic identifier, the natural language textual problem description being received from the client user profile;
in response to the request to match, controlling a term matching computing component to match the natural language textual problem description with a support topic identifier, the matching with the term matching computing component comprising:
processing the description of the problem to produce a term set that includes a set of terms derived from the description of the problem, the term set being different from the description of the problem;
accessing a graph of terms, the graph of terms being a data structure that links terms to support topic identifiers;
matching one or more terms in the term set with one or more terms in the graph of terms;
generating scores based on the matching of the one or more terms in the term set with one or more terms in the graph of terms; and
comparing the scores to match the term set with a support topic identifier;
controlling a support ticket generation component to generate a support ticket using the support topic identifier; and
using the support topic identifier to send the support ticket to a support agent profile group, the support ticket requesting a communication from the support agent profile group regarding the problem described in the description of the problem, and the support agent profile group comprising one or more computer-readable support agent user profiles.

10. The computer system of claim 9, wherein the acts further comprise sending a responsive communication in response to the support ticket, the sending of the responsive communication comprising sending the responsive communication from the support agent profile group to the client user profile.

11. The computer system of claim 10, wherein the responsive communication is selected from a group consisting of a real-time audio session communication, a real-time video session communication, an email message, a text message, a chat message, and combinations thereof.

12. The computer system of claim 9, wherein the processing of the description of the problem description comprises:
accessing a data structure that indicates dispensable terms to be removed from problem descriptions;
accessing the description of the problem;
identifying one or more dispensable terms in the description of the problem using the data structure; and
omitting the one or more dispensable terms from the term set.

13. The computer system of claim 12, wherein the processing of the description of the problem further comprises:
identifying a word in the description of the problem that is not a root word;
converting the identified word into a root word for the identified word; and
including in the term set the root word for the identified word.

14. The computer system of claim 9, wherein the graph of terms is divided into levels, and wherein the matching of the terms in the term set with one or more terms in the graph of terms comprises performing term matching at multiple levels of the graph of terms.

15. The computer system of claim 14, wherein performing term matching at multiple levels of the graph of terms comprises:
performing term matching for each of multiple nodes in a first level of the graph of terms to produce scores for each of the multiple nodes in the first level;
using the scores for the first level of the graph to choose a first level chosen node of the multiple nodes in the first level as a match for the term set;
performing term matching for each of multiple nodes in a second level of the graph to produce scores for each of the multiple nodes in the second level, with each of the multiple nodes in the second level of the graph being linked to the first level chosen node, so that the multiple nodes in the second level are grouped under the first level chosen node within the graph of terms; and
using the scores for the second level of the graph to choose a second level chosen node of the multiple nodes in the second level as a match for the set of terms, wherein second level chosen node is assigned as a node for the support topic identifier.

16. The computer system of claim 15, wherein each of the nodes in the graph of terms comprises a list of one or more terms for the node and a weight for each of the one or more terms in the list, wherein for each node for which a score is produced, producing the score comprises:
for each term in the term set that matches a term in the list of one or more terms for the node, applying the weight for that term in that node in the graph of terms to produce a single-term score; and
combining single-term scores for each term in the term set that matches a term in the list of terms for the node to produce the score for the node.

17. The computer system of claim 16, wherein for one or more of the nodes, a weight for a high priority term in the node is increased in response to determining that the high priority term is a root word for a word in a stored description for the node.

18. The computer system of claim 16, wherein the acts further comprise:
accessing feedback from user profiles in response to such user profiles being informed of support topic identifiers being matched to descriptions of problems; and
adjusting one or more weights for one or more terms in one or more nodes of the graph of terms using the feedback.

19. The computer system of claim 18, wherein the adjusting of the one or more weights is performed in response to determining that a threshold level of feedback from user profiles has been received for each of the one or more terms in one or more nodes whose weights are to be adjusted, the threshold level being greater than a single instance of user feedback for each of the one or more terms in one or more nodes whose weights are to be adjusted.

20. A computer-implemented method comprising:
receiving a digital data transmission indicating assistance from one or more support personnel is to be requested;
in response to receiving the digital data transmission indicating assistance from one or more support personnel is to be requested, accessing a digital prompt and sending the digital prompt to an output device of a computer system;
in response to the digital prompt, accessing an input of natural language text comprising a portion of a textual description of a problem with a product;
as the natural language text is being input, automatically matching a portion of the natural language text already received with previously stored suggested text automatically sending the suggested text to the output device as a suggestion;
receiving through an input device of the computer system a digital data transmission selecting the suggestion;
in response to the transmission selecting the suggested text, matching the description of the problem in the suggested text with a support topic identifier, the matching comprising:
controlling a phrase matching component to access a phrase mapping data structure that links phrases to support topic identifiers, the phrase mapping data structure mapping the suggested text to the support topic identifier; and
controlling the phrase matching component to use the phrase mapping data structure to match the description of the problem with the support topic identifier;
send to a support ticket generation component a request to generate a support ticket, the support ticket requesting a communication from a support agent regarding the problem described in the description of the problem;
send a request to use the support topic identifier to send the support ticket to a destination; and
accessing a communication received in response to the support ticket; and
sending the communication received in response to the support ticket to an output device.
